(19) United States
(12) Patent Application Publication
(10) Pub. No.: US 2024/0175961 A1
(43) Pub. Date: May 30, 2024

(54) SYSTEM AND METHOD FOR SEARCHING FOR BEACONS

(71) Applicant: API-K, Le Bourget-du-Lac (FR)

(72) Inventor: Nicolas SORNIN, LA TRONCHE (FR)

(21) Appl. No.: 18/283,285

(22) PCT Filed: Mar. 24, 2022
(86) PCT No.: PCT/FR2022/050548

§ 371 Date: Sep. 21, 2023

(30) Foreign Application Priority Data
Mar. 24, 2021 (FR) FR2102934

(51) Int. Cl. G01S 1/04; A63B 29/02

(52) U.S. Cl. CPC G01S 1/045; A63B 29/021; A63B 2029/022; G01S 2201/04

(57) ABSTRACT

The invention relates to a system for searching for a target beacon (BC) attached to an object or to a living being to be located comprising said target beacon (BC) emitting a target radio signal in an emission range (P) and a detection device (F) capable of detecting the target radio signal (SC) emitted by the target beacon (BC), and to the method for searching for the corresponding target beacon (BC).

### TECHNICAL FIELD

The present disclosure concerns a method and system for searching a target beacon attached to an object or living being to be searched.

### BACKGROUND

It is known to create a system for searching a target beacon attached to an object or a living being to be searched, such as an avalanche victim detection system for example. It is also known to implement the search method executed by said target beacon search system.

The devices capable of locating people buried by an avalanche may be referred to as «AVD» Avalanche Victim Detector.

These provisions are satisfactory in that it becomes possible to locate a person in a natural environment, for example in the mountains and consequently to come to their aid when they find themselves facing a critical situation such as an avalanche for example.

Nonetheless, the operating principle of existing beacon search devices is based on the emission or detection of the intensity of an electromagnetic signal, which limits the emission range of the target beacon to be searched to a few tens of meters and complicates the search for the target beacon resulting in a difficult search method requiring regular practice to be effective. Moreover, all AVD-type devices emit similar magnetic signals and therefore an AVD-type device cannot be uniquely identified.

The present disclosure aims to solve all or part of the draw backs mentioned above.

The technical problem underlying the disclosure consists in particular in providing a system and a method for searching a target beacon attached to an object or a living being to be searched which has an emission range greater than several tens of meters, which allows the target beacon to be searched to be uniquely identified and which is simple and economical in structure.

### BRIEF SUMMARY

For this purpose, the present disclosure relates to a method for searching a target beacon attached to an object or a living being to be searched, said search method being executed by a detection device capable of detecting a target radio signal emitted by the target beacon, the search method comprising the following steps:
Reception of a target radio signal emitted by the target beacon comprising an identification information of the target beacon when said detection device is within the emission range of the target beacon;
Determination of a target distance value between the detection device and the target beacon on the basis of a calculation of a propagation time of the radio signal between the target beacon and the detection device;
Comparison of the target distance value and a reference target distance value;
If the target distance value is lower than the reference target distance value:
i. Determination of the reference target distance value based on the target distance value;
ii. Determination of a reference position based on a position of the detection device:
Determination of a location zone of the target beacon in relation to the position of the detection device according to the reference position and the reference target distance.

According to an embodiment, a LORA protocol is used. The reception of the target radio signal corresponds to a response of the target beacon to the emission of a request signal by the detection device. The distance calculation takes into account temporal information relating to the emission of the request signal and the reception of the target radio signal.

According to an embodiment, the request signal comprises an identifier of the target beacon.

According to another embodiment, the target radio signal does not comprise identification information of the target beacon. The identification of the target beacon is carried out based on the temporal correspondence between the emission of the request signal and the reception of the target radio signal.

The method for searching a target beacon may further exhibit one or more of the following characteristics, taken alone or in combination.

According to a characteristic of the method for searching a target beacon, the detection device is connected to a guidance interface, itself connected to a magnetic compass and to a GPS coordinate receiver.

In the method for searching a described target beacon, the location zone may comprise a circle centered on the reference position and having a radius defined as a function of the reference target distance.

According to a possibility, the determination of the value of the reference target distance as a function of the value of the target distance comprises an assigning of the value of the target distance to the value of the reference target distance.

The determination of a reference position as a function of a position of the detection device may comprise the assigning of the position of the detection device to the reference position.

The method for searching a described target beacon may further comprise the following steps:
Reception of a location signal comprising a location information of the target beacon when the detection device is within the emission range of the target beacon;
Emission of a control signal comprising an order to emit the target radio signal:

The location signal may contain location information as well as an identification information of the target beacon.

The control signal may comprise a command to operate the target beacon as an emitter of the target radio signal in addition to the order to emit the target radio signal of the target beacon.

The location signal may for example contain an identifier of the target beacon such as a MAC address, geolocation coordinates of the target beacon such as GPS coordinates, a precise time at which the last known GPS coordinates of the target beacon among others are calculated.

The control signal designates a signal sent by the detection device by which the detection device controls the target beacon to be configured as a radio frequency emitter so that the target beacon can emit the target radio signal.

The method for searching a target beacon may further comprise the following steps of:
If the value of the target distance is less than the value of the reference target distance, controlling the displacement of the detection device along a straight line displacement trajectory;
If the value of the target distance is greater than the value of the reference target distance, controlling the displacement of the detection device according to a trajectory guided on the circle centered on the reference position and presenting a radius defined as a function of the reference target distance.

The method for searching a target beacon may further comprise the following step:
Providing an indication on a user interface regarding the reference position and the location zone.

In the method for searching a described target beacon, providing an indication on a user interface regarding the reference position and location zone may comprise a display of a representation of the reference position and/or the location zone on a viewing device.

According to a possibility, the method for searching a target beacon comprises the following step:
Reception of an intermediate radio signal emitted by an intermediate beacon comprising a location information of the target beacon when said detection device is within the emission range of the intermediate beacon:

The reception of the intermediate radio signal emitted by the intermediate beacon can be done when said detection device is within the emission range of the intermediate beacon but outside the range of the target beacon.

The method for searching beacons may further comprise the following step:
Initialization of a reference position based on the location information received from the target beacon:

The location information received from the target beacon may designate the last location information sent by the target beacon, for example before the target beacon stops emitting the target radio signal.

According to a possibility, the steps of receiving an intermediate radio signal emitted by the intermediate beacon and determining a reference position based on the location information of the target beacon can be repeated several times.

The present disclosure also relates to a method for searching a target beacon attached to an object or to a living being to be searched, said search method being executed by the target beacon emitting within an emission range of the target beacon a target radio signal capable of being detected by a detection device, the search method comprising the following steps:
Reception of a control signal from the detection device comprising an order to emit the target radio signal;
Emission of the target radio signal comprising an identification information of the target beacon BC:

According to a characteristic of the method for searching a target beacon, the detection device is connected to a guidance interface, itself connected to a magnetic compass and to a GPS coordinate receiver.

According to a possibility, the method for searching a described target beacon further comprises the steps of:
Selecting an operating mode of the target beacon in the group comprising a first so-called normal operating mode and a second so-called distress operating mode;
Emitting a location signal comprising a location information of the target beacon.

The selection of an operating mode of the target beacon in the group comprising a first so-called normal operating mode and a second so-called distress operating mode can be done:
on the basis of an operating mode command sent by a user of the target beacon search system.
by an action of a carrier of the target beacon in a particular situation where he would need help.

The first so-called normal operating mode designates an operation mode of the target beacon in which the target beacon emits a location signal comprising a location information of the target beacon which can be received by the detection device when the detection device is within the emission range of the target beacon.

The second so-called distress operating mode designates an operation mode of the target beacon in which an intermediate beacon is capable of reemitting the location signal of the target beacon. This distress mode allows the detection device to receive the location signal from the target beacon without being within the emission range of the target beacon.

Thus, the target beacon emits the location signal which may comprise a distress marker indicating to the intermediate beacon which receives the location signal from the target beacon to reemit it. This allows the detection device to receive the location signal either directly or through the intermediate beacon which provides a relay between the target beacon and the detection device.

The disclosure also concerns a system for searching a target beacon intended to be attached to an object or living being to be searched, comprising:
the target beacon intended to be attached to an object or a living being and emitting within an emission range of the target beacon, a target radio signal comprising an identification information of the target beacon, the target beacon being configured to implement the method previously described;
a detection device capable of detecting the target radio signal emitted by the target beacon when said detection device is in the emission range of the target beacon, the detection device comprising a calculation unit implementing the method previously described.

The target beacon search system may further exhibit one or more of the following features, taken alone or in combination.

According to a characteristic of the target beacon search system, the detection device is connected to a guidance interface, itself connected to a magnetic compass and to a GPS coordinate receiver.

The target beacon can for example be attached to a skier or a mountaineer or a person traveling in a difficult-to-access environment such as a mountain, a forest or an urban environment.

The target beacon can further be attached to a wild animal displacing in an environment that is difficult to access or even to a lost or stolen object that one wishes to locate.

The target beacon may contain a transceiver component which emits the radio signal such as an antenna and in particular an omnidirectional antenna for example.

The identification information comprised in the target radio signal and in the location signal can designate a unique identifier relating to the target beacon such as a MAC address for example.

The location information can for example designate GPS coordinates relating to the target beacon comprised in the location signal.

Advantageously, the radio signal emitted or received by the target beacon has a range of several kilometers and for example a range greater than 3 kilometers.

The detection device can also contain a transceiver component which receives the radio signal such as an omnidirectional antenna for example.

The system for searching a target beacon may further comprise:
An intermediate beacon configured to detect a location signal emitted by the target beacon, and to emit an intermediate signal comprising a location information of the target beacon when said detection device is within the emission range of the intermediate beacon.

The intermediate beacon may comprise a memory circuit capable of storing the location information of the target beacon comprised in the location signal while waiting its reemission.

The detection device may be configured to measure a target distance between the detection device and the target beacon based on a calculation of a propagation time of the target radio signal between the target beacon and the detection device.

According to a possibility, the detection device is comprised in an aerodyne.

The aerodyne can for example designate a helicopter, a drone or an aircraft.

The detection device F can be connected to a guidance interface.

The guidance interface can be connected to a magnetic compass and a GPS coordinate receiver.

The guidance interface can be visual, and in this case, it can be a viewing device, it can also be audio or textual.

According to an embodiment, the target beacon comprises a coordinate receiver and in particular a GPS coordinate receiver.

Advantageously, the target beacon can be powered by a rechargeable battery giving it autonomy for several days.

When the GPS receiver of the target beacon is incapable of receiving satellite signals necessary for calculating a position of said GPS receiver of the target beacon and therefore when the GPS coordinates of the target beacon are not known at a defined time, the beacon target transmits its last known GPS coordinates as well as an age of these known GPS coordinates, in other words the precise moment at which a calculation of the last known GPS coordinates of the target beacon took place.

### BRIEF DESCRIPTION OF THE DRAWINGS

The disclosure will be better understood using the detailed description which is set out below with regard to the appended drawings in which:

FIG. 1 is a flowchart which shows different exchanges of radio signals between a target beacon to be searched and a detection device during an execution of a first embodiment of a method for searching the target beacon.

FIG. 2 is a flowchart which shows different exchanges of radio signals between the target beacon to be searched and the detection device during an execution of a second implementation mode of the method for searching the target beacon.

FIG. 3 is a flowchart which shows different exchanges of radio signals between the target beacon to be searched, the detection device and an intermediate beacon during an execution of a third implementation mode of the method for searching the target beacon.

FIG. 4 is a schematic representation of a target beacon search system of FIGS. 1, 2 and 3 showing the target beacon to be searched and the detection device.

FIG. 5 is a schematic representation of the system for searching the target beacon, the search system comprising an intermediate beacon and implementing the method described in FIG. 3.

FIG. 6 is a schematic representation showing on the right of the figure a displacement trajectory of the detection device and a position of the target beacon to be searched, and on the left of the figure a display of a position of the detection device and a distance separating it from the target beacon to be searched.

FIG. 7 is a schematic representation showing on the right the passage of the detection device next to the target beacon and on the left the display of the position of the corresponding device.

FIG. 8 is a schematic representation showing a deviation in the trajectory of the detection device with a view to a return to the position of the target beacon, and on the left the display of the position of the corresponding device.

FIG. 9 is a schematic representation showing the continuation of the deviation in the trajectory of the detection device of FIG. 8 with a view to a return to the position of the target beacon, and on the left the display of the position of the corresponding device.

FIG. 10 is a schematic representation showing the continuation of the trajectory of the detection device of FIGS. 8 and 9 when the detection device joins the position of the target beacon, and on the left the display of the position of the corresponding device.

In the detailed description which follows of the figures defined above, the same elements or the elements fulfilling identical functions may retain the same references so as to simplify the understanding of the disclosure.

### DETAILED DESCRIPTION

The disclosure concerns a method for searching a target beacon BC by a detection device F capable of detecting a target radio signal SC emitted by the target beacon, the target beacon BC being attached to an object or to a living being to be searched.

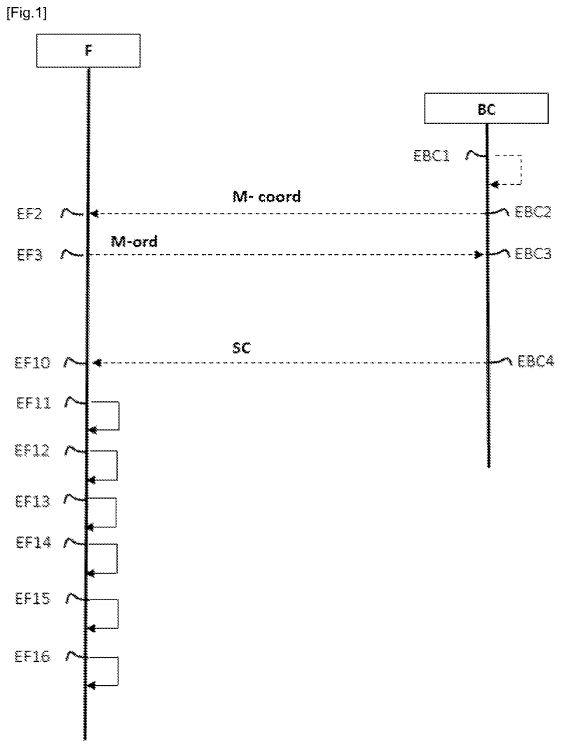

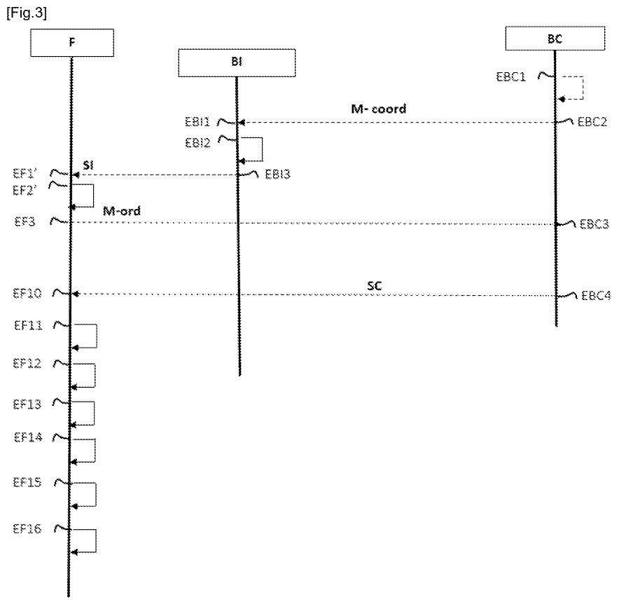

The different steps of the search method are presented in FIGS. 1, 2 and 3.

The target beacon BC can first carry out an emission EBC2 of a location signal M-Coord comprising location information of the target beacon BC as shown in FIGS. 1, 2 and 3.

If the detection device F is within the emission range P of the target beacon BC, this device receives in a step EF2 the location signal M-Coord comprising a location information of the target beacon BC, followed by an emission EF3 by the detection device F of a control signal M-ord comprising an order to emit the target radio signal SC from the target beacon BC to the detection device F.

The location signal M-coord may contain a location information as well as an identification information of the target beacon BC.

The control signal M-ord can comprise a command to operate the target beacon BC as an emitter of the target radio signal SC in addition to the order to emit the target radio signal SC of the target beacon BC. The location signal M-Coord may for example contain an identifier of the target beacon BC such as a MAC address, geolocation coordinates of the target beacon BC such as GPS coordinates and a precise instant at which the last known GPS coordinates of the target beacon BC among others are calculated.

The control signal M-ord denotes a signal sent by the detection device F by which the detection device F controls the target beacon BC to be configured as a radiofrequency emitter so that the target beacon BC can emit the target radio signal SC.

According to an implementation mode, a LORA protocol for long range is used. The reception of the target radio signal SC corresponds to a response from the target beacon BC to the emission of a control signal M-ord by the detection device F. The calculation of the distance takes into account time information relating to the emission of the request signal and reception of the target radio signal SC.

In another implementation mode, the target radio signal SC may not comprise information identifying the target beacon BC. The identification of the target beacon is carried out based on the temporal correspondence between the emission of the request signal and the reception of the target radio signal SC.

Then, as presented in FIGS. 1, 2 and 3, the target beacon BC performs the reception EBC3 of a control signal M-ord coming from the detection device F comprising a command to operate the target beacon BC as emitter of the target radio signal SC and an order to emit the target radio signal to the detection device F, followed by an emission EBC4 by the target beacon BC of the target radio signal SC.

The target radio signal SC is then received by the detection device F during a reception step EF10 of a target radio signal SC emitted by the target beacon BC, and the detection device F determines a value of a target distance EF11 between the detection device F and the target beacon BC on the basis of a calculation of a propagation time of the radio signal between the target beacon BC and the detection device F.

The detection device F then performs a comparison EF12 of the target distance value and a reference target distance value.

If the value of the target distance is less than the value of the reference target distance or if the value of the reference target distance is not determined, then the detection device proceeds to determine EF13 the value of the reference target distance Rmin depending on the value of the target distance. The detection device F also proceeds to a determination EF14 of a reference position Pmin as a function of a position of the detection device F, then to a determination EF15 of a location zone Z of the target beacon BC with respect to the position of the detection device F as a function of the reference position and of the reference target distance.

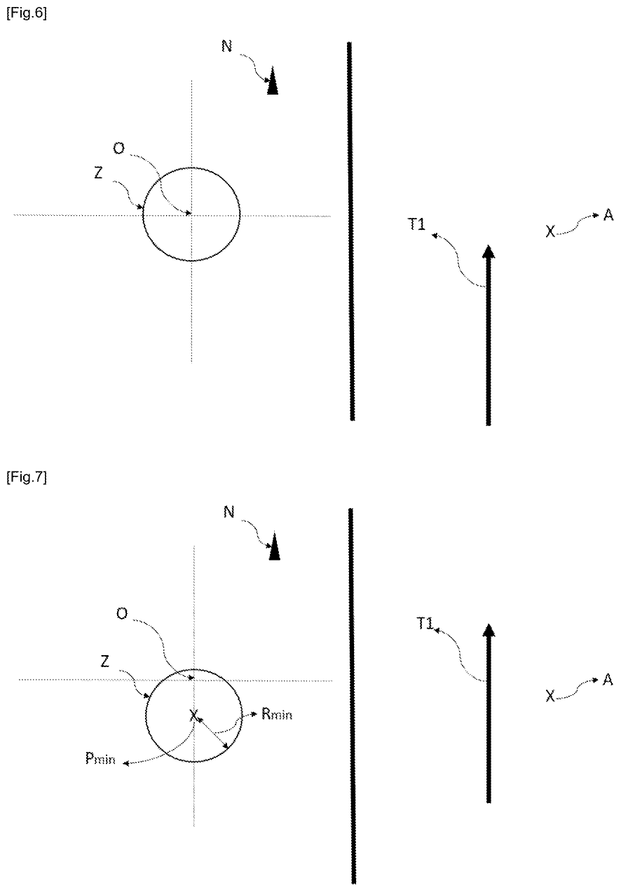

The location zone Z presented in FIG. 6 can for example comprise a circle centered on the reference position Pmin and having a radius defined as a function of the reference target distance Rmin.

The determination EF13 of the value of the target distance as a function of the value of the reference target distance Rmin can comprise an assignment of the value of the target distance to the value of the reference target distance Rmin. In this case, the reference target distance Rmin represents the minimum distance measured between the detection device F and the target beacon BC since the start of the search for the target beacon BC.

The determination EF14 of a reference position Pmin as a function of a position of the detection device F may comprise the assignment of the position of the detection device to the reference position Pmin.

According to an implementation mode presented in FIG. 1 in which a human user such as a rescuer drives the detection device F, the method for searching a target beacon BC can further comprise a supply step EF16 by the detection device detection F of an indication on a user interface concerning the reference position Pmin and the location zone Z.

The provision EF16 of an indication on a user interface concerning the reference position Pmin and the location zone Z comprises a display of a representation of the reference position Pmin and/or of the location zone Z on a viewing device.

An example of the display representing the reference position Pmin and/or the location zone Z on a viewing device is shown in FIGS. 6 to 10. FIGS. 6 to 10 can represent a search for the target beacon by the detection device comprised in an aerodyne.

According to an example, the rescuer driving the detection device F selects any steering direction. It can also select a steering direction leading to the last known GPS coordinates of the target beacon BC.

Thus, it can be seen on the right of FIG. 6 a straight trajectory T1 of the detection device F which is heading towards a position A of the target beacon BC. On the left, the corresponding display on the viewing device shows a displacement of the detection device F to the north N with a position reticle O of the detection device F centered on the location zone Z. As long as the distance separating the detection device F from the target beacon BC decreases, the detection device F maintains its straight trajectory T1. If the distance separating the detection device F from the target beacon BC increases, then the rescuer performs a U-turn in order to approach the position A of the target beacon BC.

The viewing device permanently displays the position of the detection device F as well as the reference target distance Rmin. As long as the distance separating the detection device F from the target beacon BC decreases, the position reticle O and the reference position Pmin coincide on the viewing device.

At a given instant presented in FIG. 7, the detection device F, continuing its displacement in the trajectory T1, exceeds the position A of the target beacon; the target distance then passes through a minimum equivalent to the reference target distance Rmin and starts again to increase. On the viewing device, the position reticle O and reference position Pmin no longer coincide. The rescuer can then observe that the position reticle O has exceeded the reference target distance Rmin. The target beacon BC is somewhere in the circle having as radius the reference target distance Rmin, without the rescuer knowing in which direction the target beacon BC is located.

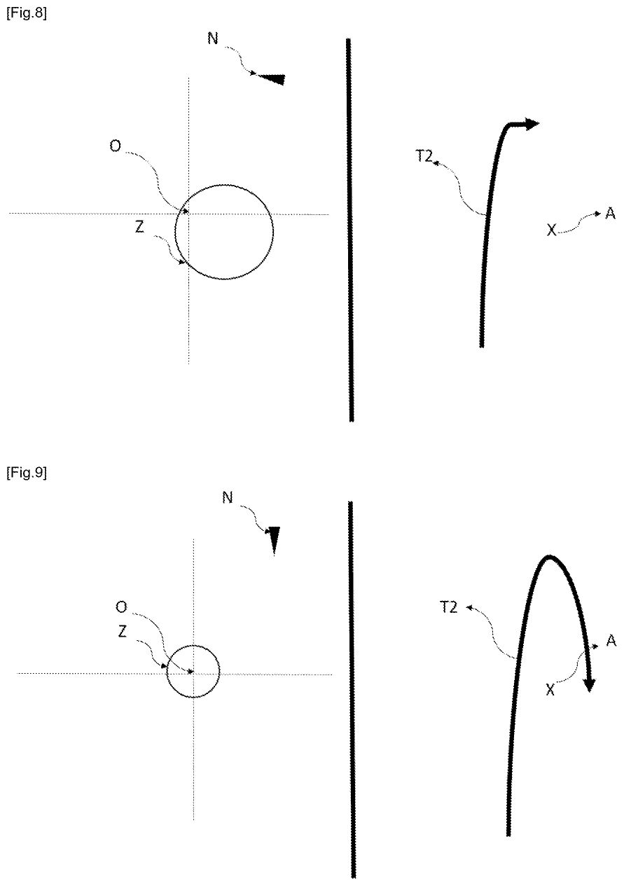

When the position reticle O is in intersection with the circle whose radius is the reference target distance Rmin, the rescuer modifies the trajectory of the detection device F to engage it on a circular trajectory T2 and which coincides as best as possible with the circle having as radius the reference target distance Rmin. The rescuer can for example modify the trajectory of the detection device F by making a quarter turn. The trajectory T2 brings the detection device F closer to the target beacon BC as is the case in FIG. 8.

This results in the position reticle O and the reference position Pmin again coinciding on the display of the viewing device as is the case in FIG. 9) since the position of the detection device F corresponds to the reference position Pmin in this case, and that the target distance corresponds to the reference target distance Rmin.

The rescuer maintains the trajectory T2 of the detection device without deviating as long as the target distance decreases and the position reticle O and the reference position Pmin coincide.

When on the display of the viewing device, the position reticle O and the reference position Pmin no longer coincide, the rescuer can for example make a turn in the trajectory T2 of the detection device F as soon as the position reticle O crosses the circle having as radius the reference target distance Rmin so that the position reticle O describes part of the circle having as radius the reference target distance Rmin.

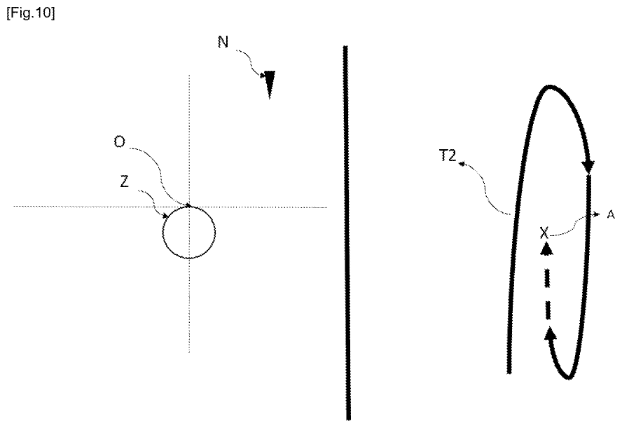

The driving maneuvers of the detection device F presented in FIGS. 6 to 10 can be repeated in order to obtain a spiral trajectory T2 like that of FIG. 10, and this in order to bring the detection device F to a position substantially vertically from the position A of the target beacon BC.

Advantageously, the described search method does not require any landmarks on the ground, and can be implemented even in the event of poor visibility for the rescuer.

Advantageously, if the trajectory of the detection device is constrained by obstacles or weather conditions, the fact that the display of the viewing device shows the reference target distance Rmin permanently allows the pilot of the detection device F to return to the location zone of the target beacon BC regardless of the direction in which the detection device F is displaced.

Advantageously, the described search method can allow a quick and efficient search by having recourse to a reduced number of components such as the target beacon BC and the detection device F.

Advantageously, the described search method can be implemented in the case where the person or object to be searched is buried in snow for example or in a closed location such as under a rock or under cover of dense vegetation, without requiring additional means of geolocation of the target beacon BC. In other words, the described search method can be implemented even if the target beacon BC does not have a GPS receiver.

Advantageously, the described search method makes it possible to begin the search for the target beacon BC several kilometers away and to obtain, at the end of the described search method, the position of the target beacon BC with metric precision.

Advantageously, the described search method is systematic and therefore easily automatable.

Advantageously, the described search method can be implemented with omnidirectional antennas requiring no condition of direction of arrival of the target radio signal SC and easily integrated into portable equipment.

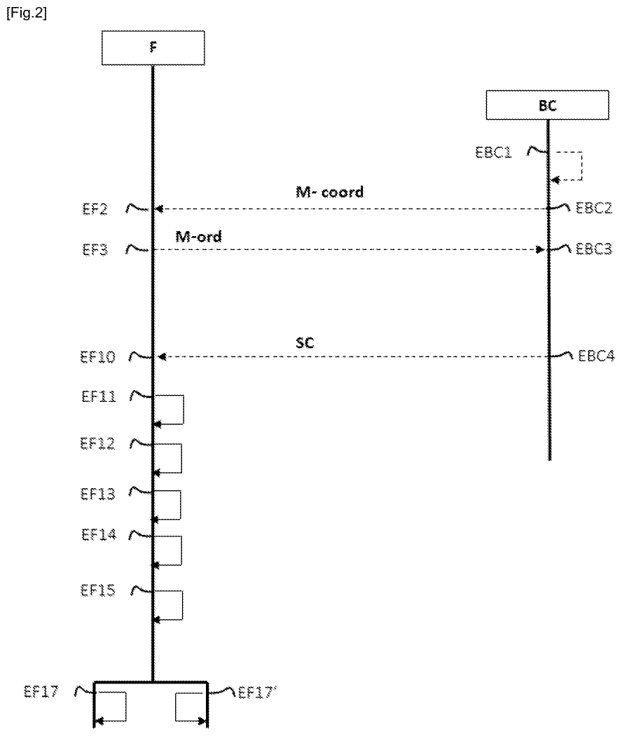

According to another implementation mode presented in FIG. 2 in which the detection device is automatically driven, by a computer software for example, in particular as when the detection device is comprised in a drone, then the search method of a target beacon BC further comprises a step of controlling EF17 the displacement of the detection device F along a trajectory T1 of displacement in a straight line if the value of the target distance is less than the value of the reference target distance Rmin, as well as a step of controlling EF17′ the displacement of the detection device F along a trajectory T2 guided on the circle centered on the reference position Pmin and having a radius defined as a function of the reference target distance Rmin if the value of the target distance is greater than the value of the reference target distance Rmin.

### Distress Mode and Intermediate Beacon

Before executing the step of emitting EBC2 a location signal M-Coord, the target beacon BC can make a selection EBC1 of an operating mode of the target beacon BC in the group comprising a first so-called normal operating mode and a second so-called distress operating mode.

The selection EBC1 of an operating mode of the target beacon in the group comprising a first so-called normal operating mode and a second so-called distress operating mode can be done for example on instructions from the user.

The selection EBC1 of an operating mode of the target beacon BC in the group comprising a first so-called normal operating mode and a second so-called distress operating mode can be done:
on the basis of a command of an operating mode sent by a user of the target beacon search system.
by an action of a carrier of the target beacon in a particular situation where he would need help.

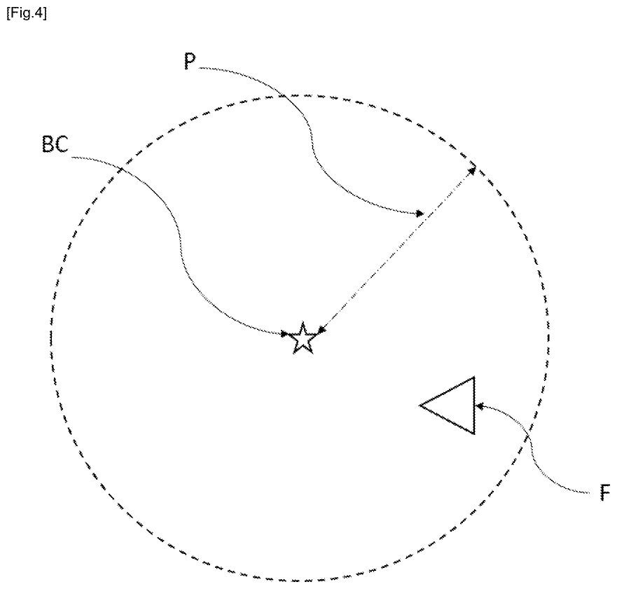

The first so-called normal operating mode is presented in FIG. 4 and designates an operating mode of the target beacon in which the target beacon BC emits a location signal M-coord comprising a location information of the target beacon BC which can be received by the detection device F when the detection device is within the emission range of the target beacon BC.

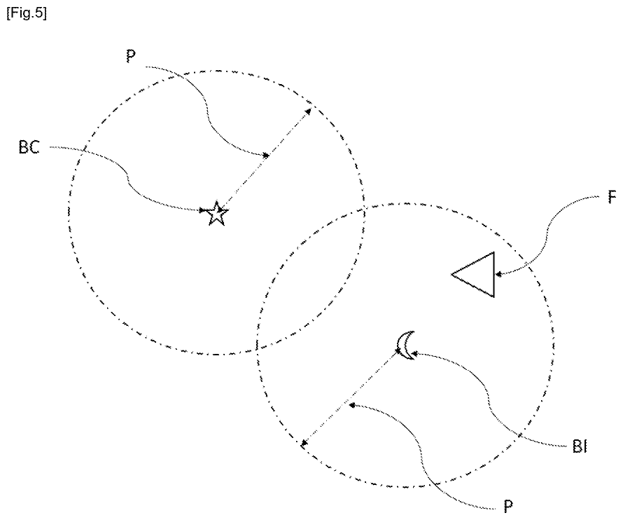

The second so-called distress operating mode is presented in FIG. 5 and designates an operating mode of the target beacon BC in which an intermediate beacon BI is capable of reemitting the location signal M-coord of the target beacon BC. This distress mode allows the detection device F to receive the location signal M-coord from the target beacon BC without being within the emission range of the target beacon BC.

Thus, the target beacon BC emits the location signal M-coord which may comprise a distress marker indicating to the intermediate beacon BI which receives the location signal M-coord from the target beacon BC to reemit it. This allows the detection device F to receive the location signal M-coord either directly or through the intermediate beacon BI which ensures a relay between the target beacon BC and the detection device F.

Thus, the method for searching a target beacon BC can further comprise a step of receiving EF1′ an intermediate radio signal SI emitted by the intermediate beacon BI comprising a location information of the target beacon BC when said detection device F is within the emission range P of the intermediate beacon BI, as well as a step of initializing EF2′ a reference position Pmin according to the location information of the target beacon BC. The location information received from the target beacon BC may designate the last location information sent by the target beacon BC, for example before the target beacon BC stops emitting the target radio signal SC. According to a possibility, the steps of receiving EF1′ an intermediate radio signal SI emitted by the intermediate beacon BI and of initializing EF2″ a reference position Pmin as a function of the location information of the target beacon BC can be repeated several times.

The disclosure further concerns a system for searching a target beacon BC intended to be attached to an object or to a living being to be searched, comprising the target beacon BC intended to be attached to an object or to a living being and emitting in the emission range P of the target beacon BC the target radio signal SC comprising the identification information of the target beacon BC, the target beacon BC being configured to implement the search method previously described.

The target beacon BC shown in FIGS. 4 and 5 can for example be attached to a skier or a mountaineer or a person traveling in a difficult to access environment such as a mountain, a forest or an urban environment.

The target beacon BC can further be attached to a wild animal displacing in an environment that is difficult to access or even to a lost or stolen object which is desired to be located.

Advantageously, the emission range P of the target beacon BC can be several kilometers and it can be greater than 3 kilometers for example.

According to a possibility, the target beacon BC contains a transceiver component which emits the radio signal like an antenna and in particular an omnidirectional antenna for example.

The identification information comprised in the target radio signal SC and in the location signal can designate a unique identifier relating to the target beacon BC such as a MAC address for example and the location information can for example designate relative GPS coordinates to the target beacon BC comprised in the location signal.

The target beacon BC may comprise a coordinate receiver and in particular a GPS coordinate receiver.

Advantageously, the BC target beacon can be powered by a rechargeable battery giving it autonomy for several days.

According to a possibility, when the GPS receiver of the target beacon BC is unable to be connected to a navigation network and therefore when the GPS coordinates of the target beacon BC are not known at a defined time, the target beacon BC transmits its latest known GPS coordinates as well as an age of these known GPS coordinates, in other words the precise moment at which a calculation of the last known GPS coordinates of the target beacon BC took place.

The system for searching the target beacon BC further comprises a detection device F presented in FIGS. 4 and 5 and capable of detecting the target radio signal SC emitted by the target beacon BC when said detection device F is within the emission range P of the target beacon BC, the detection device F comprising a calculation unit implementing the method previously described.

The detection device F may contain a transceiver component which receives the target radio signal SC such as an omnidirectional antenna for example.

According to a possibility, the detection device F is configured to measure a target distance between the detection device F and the target beacon BC on the basis of a calculation of a propagation time of the target radio signal SC between the target beacon BC and the detection device F.

The detection device F can be comprised in an aerodyne such as a helicopter, a drone or an aircraft. The detection device F can also be comprised in a vehicle displacing normally on the ground such as a car.

According to a possibility, the detection device can be worn by a human user displacing on foot.

The detection device F can be connected to a guidance interface, the guidance interface itself being connected to a magnetic compass and to a GPS coordinate receiver.

The guidance interface can be visual, and in this case it can be a viewing device such as a tablet screen for example, it can also be audio or textual.

According to an embodiment, the system for searching a target beacon BC can also comprise an intermediate beacon BI shown in FIG. 5 configured to detect the location signal M-coord emitted by the target beacon BC, and to emit an intermediate signal SI comprising the location information of the target beacon BC when said detection device F is within the emission range P of the intermediate beacon BI.

The intermediate beacon BI may comprise a memory circuit capable of storing the location information of the target beacon BC comprised in the location signal M-coord while awaiting its reemission.

Although the disclosure has been described in conjunction with specific embodiments, it is obvious that it is in no way limited thereto and that it comprises all the technical equivalents of the means described as well as their combinations if these fall within the scope of the disclosure.

1. A method for searching a target beacon attached to an object or living being to be searched, said search method being executed by a detection device capable of detecting a target radio signal emitted by the target beacon, the search method comprising the following steps:
reception of a target radio signal emitted by the target beacon comprising an identification information of the target beacon when said detection device is within the emission range of the target beacon;
determination of a value of a target distance between the detection device and the target beacon based on a calculation of a propagation time of the radio signal between the target beacon and the detection device;
comparison of the target distance value and a reference target distance value;
if the target distance value is less than the reference target distance value or if the reference target distance value is not determined:
i. determination of the value of the reference target distance according to the value of the target distance;
ii. determination of a reference position as a function of a position of the detection device;
determination of a location zone of the target beacon relative to the position of the detection device as a function of the reference position and the reference target distance.

2. The method for searching for a target beacon according to claim 1, wherein the detection device is connected to a guidance interface, itself connected to a magnetic compass and to a GPS coordinate receiver.

3. The method for searching a target beacon according to claim 1, wherein the location zone comprises a circle centered on the reference position and having a radius defined as a function of the reference target distance.

4. The method for searching a target beacon according to claim 1, wherein the determination of the value of the target distance as a function of the value of the reference target distance comprises an assignment of the value of the target distance to the value of the reference target distance.

5. The method for searching a target beacon according to claim 1, wherein the determination of a reference position as a function of a position of the detection device comprises the assignment of the position of the detection device to the reference position.

6. The method for searching a target beacon according to claim 1, further comprising the following steps:
reception of a location signal comprising a location information of the target beacon when the detection device is within the emission range of the target beacon;
emission of a control signal comprising an order to emit the target radio signal from the target beacon to the detection device;

7. The method for searching a target beacon according to claim 1, further comprising the following steps of:
if the value of the target distance is less than the value of the reference target distance, controlling the displacement of the detection device along a trajectory of displacement in a straight line;
if the value of the target distance is greater than the value of the reference target distance, controlling (EF17″) the displacement of the detection device along a trajectory guided on the circle centered on the reference position and having a radius defined as a function of the reference target distance.

8. The method for searching a target beacon according to claim 1, further comprising the following step:
provision of an indication on a user interface concerning the reference position and the location zone.

9. The method for searching a target beacon according to claim 8, wherein the provision of an indication on a user interface concerning the reference position and the location zone comprises a display of a representation of the reference position and/or the location zone on a viewing device.

10. The method for searching a target beacon according to claim 1, further comprising the following step:
reception of an intermediate radio signal emitted by an intermediate beacon comprising a location information of the target beacon when said detection device is within the emission range of the intermediate beacon;

11. The method for searching a beacon according to claim 1, further comprising the following step:
initialization of a reference position according to the location information of the target beacon

12. The method for searching a target beacon attached to an object or living being to be searched, said search method being executed by the target beacon emitting within an emission range of the target beacon a target radio signal capable of being detected by a detection device, the search method comprising the following steps:
reception of a control signal (M-ord) coming from the detection device comprising a command to operate the target beacon as emitter of the target radio signal and an order to emit the target radio signal to the detection device;
emission of the target radio signal comprising an information identifying the target beacon.

13. The method for searching a target beacon according to claim 12, wherein the detection device is connected to a guidance interface, itself connected to a magnetic compass and to a GPS coordinate receiver.

14. The method for searching a target beacon according to claim 12 further comprising the steps of:
selecting an operating mode of the target beacon in the group comprising a first so-called normal operating mode and a second so-called distress operating mode;
emitting a location signal comprising a location information of the target beacon.

15. A system for searching a target beacon intended to be attached to an object or living being to be searched comprising:
the target beacon intended to be attached to an object or to a living being and emitting within an emission range of the target beacon a target radio signal comprising an identification information of the target beacon, the target beacon being configured to implement the method according to claim 12;
a detection device capable of detecting the target radio signal emitted by the target beacon when said detection device is within the emission range of the target beacon, the detection device comprising a calculation unit implementing a method for searching a target beacon attached to an object or living being to be searched, said search method being executed by a detection device capable of detecting a target radio signal emitted by the target beacon, the search method comprising the following steps: reception of a target radio signal emitted by the target beacon comprising an identification information of the target beacon when said detection device is within the emission range of the target beacon; determination of a value of a target distance between the detection device and the target beacon based on a calculation of a propagation time of the radio signal between the target beacon and the detection device; comparison of the target distance value and a reference target distance value; if the target distance value is less than the reference target distance value or if the reference target distance value is not determined; determination of the value of the reference target distance according to the value of the target distance; determination of a reference position as a function of a position of the detection device; determination of a location zone of the target beacon relative to the position of the detection device as a function of the reference position and the reference target distance.

16. The system for searching a target beacon according to claim 15, wherein the detection device is connected to a guidance interface, itself connected to a magnetic compass and to a GPS coordinate receiver.

17. The system for searching a target beacon according to claim 15 further comprising:
an intermediate beacon configured to detect a location signal emitted by the target beacon, and to emit an intermediate signal comprising a location information of the target beacon when said detection device is within the emission range of the intermediate beacon.

18. The system for searching a target beacon according to claim 17 wherein the intermediate beacon comprises a memory circuit capable of storing the location information of the target beacon comprised in the location signal.

19. The system for searching a target beacon according to claim 15, wherein the detection device is configured to measure a target distance between the detection device and the target beacon based on a calculation of a propagation time of the target radio signal between the target beacon and the detection device.

20. The system for searching a target beacon according to claim 15, wherein the detection device is comprised in an aerodyne.

21. The system for searching a target beacon according to claim 15 wherein the target beacon comprises a coordinate receiver and in particular a GPS coordinate receiver.
